(19) United States
(12) Patent Application Publication
(10) Pub. No.: US 2023/0214134 A1
(43) Pub. Date: Jul. 6, 2023

(54) STORAGE DEVICE AND CONTROL METHOD THEREFOR

(71) Applicant: Hitachi, Ltd., Tokyo (JP)

(72) Inventors: Takashi NAGAO, Tokyo (JP); Tomohiro YOSHIHARA, Tokyo (JP); Hiroki FUJII, Tokyo (JP)

(21) Appl. No.: 17/939,789

(22) Filed: Sep. 7, 2022

(30) Foreign Application Priority Data
Jan. 6, 2022 (JP) 2022-000846

(51) Int. Cl. G06F 3/06

(52) U.S. Cl. CPC G06F 3/0622; G06F 3/0619; G06F 3/0631; G06F 3/0665; G06F 3/0683

(57) ABSTRACT

A storage controller manages a logical volume to which a host makes an access and which manages host data, an addition address space which is mapped with the logical volume and to which host data is added, and a physical address space which is mapped with the addition address space. In the addition address space, different address regions are allocated to respective parity groups. The storage controller selects, as an addition area of host data supplied from the host, an unoccupied address region in the addition address space. As the addition area, a region mapped to a normal status parity group in which data recovery is unnecessary is more preferentially selected than a region allocated to an abnormal status parity group in which data recovery is necessary.

### CLAIM OF PRIORITY

The present application claims priority from Japanese patent application JP 2022-000846 filed on Jan. 6, 2022, the content of which is hereby incorporated by reference into this application.

### BACKGROUND OF THE INVENTION

### 1. Field of the Invention

The present invention relates to a storage device and a control method therefor.

### 2. Description of the Related Art

Storage devices that do not stop tasks during a drive failure or during a data transfer, for example, have been demanded. In order to continue inputting/outputting (I/O) to/from a storage device during a drive failure, the redundant array of independent disk (RAID) technology has been widely used.

In the RAID technology, data and a redundant code (parity) generated from the data are stored into a plurality of drives. The RAID technology uses parity. Therefore, even when a drive in a group has failed, information in another drive can be used to recover data, so that inputting/outputting to/from a storage device can be continued.

A failed storage drive is exchanged with a sound one, and data recovered on the basis of data in another storage drive is stored into the sound storage drive. Accordingly, a condition before the failure can be restored. However, if the other drive fails during the restoration, data cannot be recovered (data lost). Therefore, it is important to shorten a time required for the restoration, and to recover the redundancy as quickly as possible. Extension of a recovery time period due to the continuing I/O should be inhibited.

Besides, storage devices having a data deleting function have been known (see U.S. Pat. Application Publication No. 2019/0243582, for example). The data deleting function uses compression of data and elimination of a duplication. In a case where the data deleting function is enabled, the amount of data actually stored in a drive is smaller than the amount of data written by a host. In order to efficiently store data into drives, data having undergone duplication elimination or compression is placed from the front side in a layer which is called addition space, and then, data is stored into the drives.

### SUMMARY OF THE INVENTION

In an abnormal status in which a drive has failed or data transfer is being conducted, for example, it is desired to accept data writing from a host in order to continue tasks. If data is written into a parity group including a failed drive, the data is also necessarily generated again after the drive is exchanged. Thus, a time period (recovery time period) required to generate the data again becomes longer. If data is written into a parity group in which a transfer is being performed, differential data after the transfer is necessarily recovered, whereby a process time is increased. Therefore, a technology in which additional processes can be reduced while data writing is constantly accepted, has been desired.

A storage device according to one aspect of the present disclosure includes: a storage controller that accepts access made by a host; and a plurality of storage drives that each store host data, in which the plurality of storage drives include a plurality of parity groups, the storage controller manages a logical volume to which the host makes an access and which manages host data, an addition address space which is mapped with the logical volume and to which host data is added, and a physical address space in the plurality of storage drives, the physical address space being mapped with the addition address space, in the addition address space, different address regions are allocated to the respective parity groups, in the addition address space, an unoccupied address region is selected as an addition area of host data supplied from the host, and as the addition area, a region mapped to a normal status parity group in which data recovery is unnecessary is more preferentially selected than a region allocated to an abnormal status parity group in which data recovery is necessary.

Additional processes can be reduced while data writing is constantly accepted.

### BRIEF DESCRIPTION OF THE DRAWINGS

FIG. 1 roughly depicts a method of selecting an addition area of host data according to a first embodiment;

FIG. 2 is a diagram depicting one example of a configuration of an information system;

FIG. 3 is a diagram depicting the correspondence among a LUN, a pool, address spaces of storage drives, pages in the pool, and pages in the address spaces of the storage drives in a storage device;

FIG. 4 shows a configuration example of a host address management table;

FIG. 5 shows a configuration example of an addition address management table;

FIG. 6 shows a configuration example of a page management table;

FIG. 7 shows a configuration example of a parity group management table;

FIG. 8 shows a configuration example of a drive management table in which storage drives are managed;

FIG. 9 shows a flowchart of an example of a writing process of host data received from a host computer;

FIG. 10 shows a flowchart of an example of an addition area selection process in the flowchart of FIG. 9;

FIG. 11 is a flowchart of an example of a ready-to-addition page acquisition process in the flowchart of FIG. 10;

FIG. 12 is a flowchart of an example of a data recovery process;

FIG. 13 roughly depicts a method of selecting an addition area of host data according to a second embodiment;

FIG. 14 depicts a hardware configuration example of one embodiment of the present specification;

FIG. 15 shows a configuration example of a transfer status management table including management information on a storage device;

FIG. 16 shows a flowchart of an example of a writing process of host data received from a host computer according to one embodiment of the present specification;

FIG. 17 shows a flowchart of an example of an addition area selection process in the flowchart of FIG. 16;

FIG. 18 shows a flowchart of an example of a differential rebuild process;

FIG. 19 shows a flowchart of an example of an addition area selection process according to a third embodiment; and

FIG. 20 shows a flowchart of another example of the addition area selection process.

### DESCRIPTION OF THE REFERRED EMBODIMENTS

Hereinafter, embodiments will be explained with reference to the drawings. Note that the embodiments are mere illustrative embodiments for carrying out the present invention, and the technical scope of the present invention is not limited these embodiments. In addition, all combinations of the features described in the embodiments are not necessary for the solution.

In the following explanation, some types of information are expressed by “xxx table,” however, these types of information may be expressed by any data structure other than tables. A “xxx table” may be referred to as “xxx information” in order to indicate that this information is independent of a data structure. In addition, a numeric is used as identification information about an element in the following explanation. However, identification information of another type (a name or an identifier, for example) may be used therefor.

In the following explanation, a common character (or reference character) in a reference character is used for elements of the same category when these elements are not distinguished from each other, while a reference character (or element ID) is used to distinguish elements of the same category from each other.

In the following explanation, the term “main storage” may refer to at least one storage device including a memory. For example, a main memory may be a main storage device (typically, a volatile storage device) rather than an auxiliary storage device (typically, a non-volatile device). In addition, a storage section may include a cache region (e.g. a cache memory or a partial region thereof) and/or a buffer region (e.g. a buffer memory or a partial region thereof).

In the following explanation, the term “RAID” is an abbreviation of redundant array of independent (or Inexpensive) Disks. A RAID group consists of a plurality of storage drives. Data is stored in accordance with a RAID level associated with the RAID group. A RAID group is also referred to as a parity group. In the following explanation, a storage region in a “pool” is mapped with storage regions of a plurality of storage drives. That is, a pool storage region consists of storage regions in a plurality of storage drives. The storage drives may constitute a RAID group.

In the following explanation, the term “LUN” refers to a logical storage device or volume, and is mapped with some or all storage regions in a pool. That is, an LUN consists of some or all storage regions in a pool. A host issues an I/O (Input/Output) request to an “LUN.” An LUN is a logical volume. Between an LUN and storage regions in storage drives, allocation of storage regions is managed via a pool.

A program is executed by a processor (e.g. a central processing unit (CPU)) included in a storage controller so that a predetermined process is performed by using a storage resource (e.g. a main storage) and/or a communication interface device (e.g. HCA), as appropriate. The subject of such a process may be a storage controller or a processor. In addition, a storage controller may include a hardware circuit that performs a part of a process or the entire process. A computer program may be installed from a program source. A program source may be a program distribution server or a computer-readable storage medium, for example.

In the following explanation, the term “host” refers to a system that transmits an I/O request to a storage device, and may include an interface device, a storage section (e.g. a memory), and a processor connected to the interface device and the storage section. The host system may consist of one or more host computers. At least one of the host computers may be a physical computer. The host system may include a virtual host computer in addition to the physical host computer.

### First Embodiment

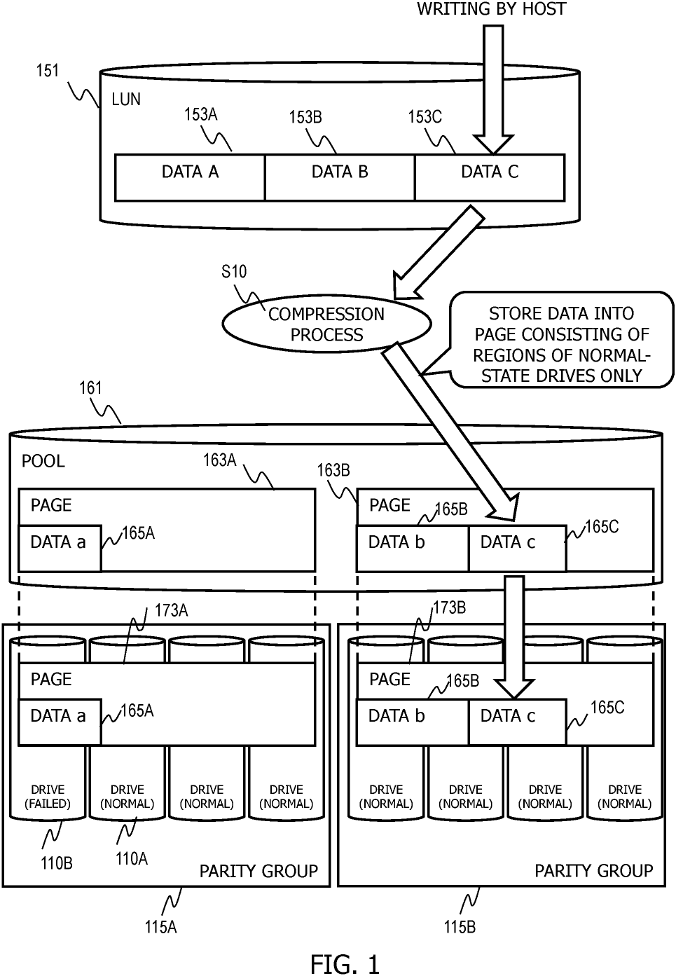

FIG. 1 roughly depicts a method of selecting an addition area of host data according to the first embodiment. A storage device generates compressed data by executing a compression process S10 on plaintext data received from an external host computer. The compressed data is stored into storage drives 110.

In the following explanation, data compression will be explained for an illustrative purpose. Elimination of a duplication may be performed together with or in place of the data compression. If elimination of a duplication is applied, at least one of duplicated data sets is deleted, and the physical addresses of the remaining data sets are associated with the logical address of the deleted duplicated data set. Any process that involves a data size change may be executed, or the above data conversion process may be omitted.

In order to input/output host data, a storage device manages a plurality of address spaces in association. Specifically, a host computer manages an LUN 151 which is a volume for data writing and reading, a pool 161 that is an address space in which compressed data is stored, and address spaces in storage drives.

In the example in FIG. 1, a plurality of storage drives constitute a parity group (RAID group). Specifically, four storage drives constitute each of parity groups 115A and 115B. The number of storage drives constituting a parity group may be optionally decided. In FIG. 1, one failed drive 110B is given as an example. The remaining storage drives are normal. One normal storage drive is indicated by reference character 110A for an illustrative purpose.

An address region of plaintext data in the LUN 151 and an address region of compressed data in the pool 161 are mapped. In addition, an address region of compressed data in the pool 161 and an address region of compressed data in an address space of a storage drive are mapped. For example, mapping between the LUN 151 and the pool 161 is variable, while mapping between the pool 161 and an address space of a storage drive is fixed. Different address regions in the pool 161 are allocated to respective parity groups.

In the configuration example depicted in FIG. 1, the pool 161 and the address spaces in the storage drives are managed in units of page. A page is an address region of a prescribed size. FIG. 1 illustrates pages 163A and 163B in the pool 161, and pages 173A and 173B in the storage drives. In address spaces in the storage drives, a page is included in an address region for one parity group. It is to be noted that the pool 161 and the address spaces in the storage drives may be managed without using a page.

In FIG. 1, plaintext data A 153A, plaintext data B 153B, and plaintext data C 153C supplied from a host are stored in the LUN 151. The plaintext data is converted to compressed data by a compression process S10. In FIG. 1, compressed data a 165A, compressed data b 165B, and compressed data c 165C are generated from the plaintext data A 153A, the plaintext data B 153B, and the plaintext data C 153C, respectively.

The compressed data a 165A is stored in the page 163A in the pool 161. The compressed data b 165B and the compressed data c 165C are stored in the page 163B in the pool 161. The page 163A is allocated to a page 173A in the parity group 115A while the page 163B is allocated to a page 173B in the parity group 115B. Therefore, the page 173A stores the compressed data a 165A while the page 163B stores the compressed data b 165B and the compressed data c 165C.

In one embodiment of the present specification, a plurality of address spaces in the storage device each have a “recordable data structure.” A recordable data structure accomplishes a data update by storing an updated data in a physical position different from a position in which the data has been stored before the updating, and changing a consultation area for the stored data. The size of compressed data depends on the content of the data before compressed. Thus, in order to enhance the efficiency in deleting data, compressed data is stored into storage drives without space. The details of a recordable data structure will be described later.

The storage device can select, from among a plurality of pages in the pool 161, a page for storing received host data. In one embodiment of the present specification, the storage device selects, as a page to which the host data is added, a page consisting of storage regions of normal-status storage drives only. Accordingly, an increase in an amount of data to be recovered during a data recovery process in a parity group, can be avoided.

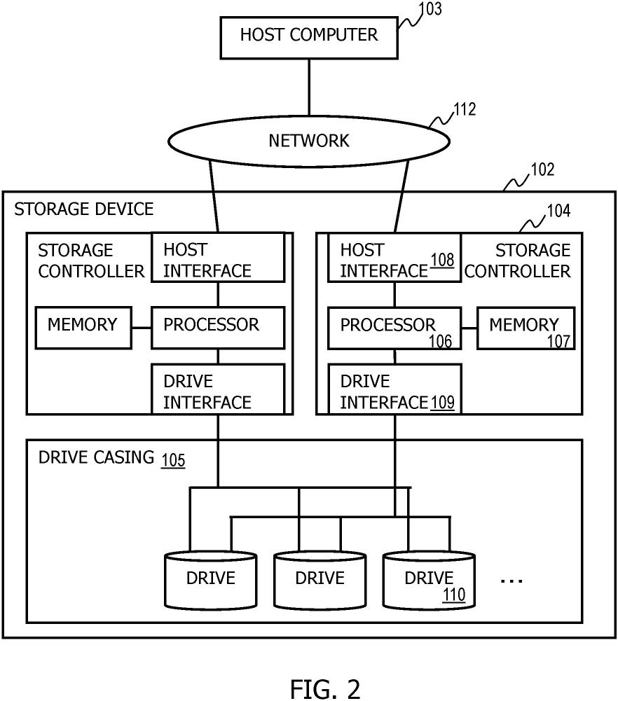

FIG. 2 is a diagram depicting one example of a configuration of an information system. The information system includes at least one storage device 102 and at least one host computer 103. The host computer 103 communicates with the storage device 102 over a network 112. The storage device 102 includes at least one storage controller 104 and at least one drive casing 105. FIG. 2 depicts two storage controllers. A reference numeral is given to one of the storage controllers for an illustrative purpose. Further, FIG. 2 depicts one drive casing.

The drive casing 105 includes a plurality of storage drives 110. In one embodiment of the present specification, the drive casing 105 includes a plurality of parity groups, and each of the parity groups includes a plurality of the storage drives 110. Each of the storage drives 110 can belong to one or more parity groups. The storage controller 104 and the drive casing 105 are directly connected to each other in FIG. 2, but may be connected via a network switch, and each of the storage controllers 104 may communicate with a plurality of drive casings.

Each of the storage drives 110 may be formed of an all flash array (AFA) having a nonvolatile semiconductor memory mounted thereon, and all or some of the storage drives 110 may be substituted by a hard disk drive (HDD). In addition, for example, a well-known or publicly known technology such as a log-structured system may be used as the recordable data structure.

The storage controller 104 includes a processor 106, a memory (main storage) 107, a host interface (I/F) 108, and a drive interface 109. The number of components constituting the storage controller 104 may be set to one or more.

The processor 106 is configured to generally control the storage controller 104, and is operated in accordance with a program stored in the memory 107. The host interface 108 exchanges an I/O request and I/O data with the host computer 103 under control of the processor 106. The drive interface 109 exchanges I/O data with the storage drives 110 via the drive casing 105 under control of the processor 106.

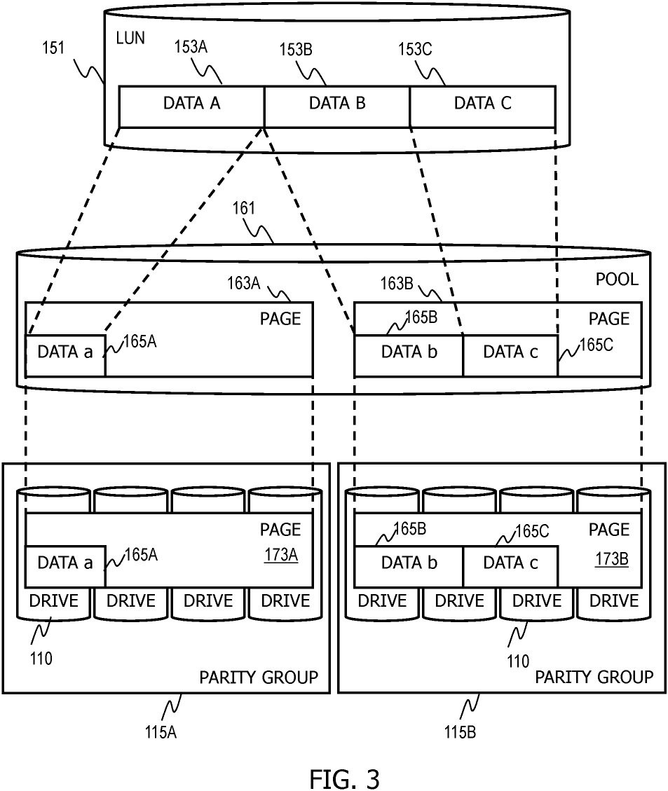

FIG. 3 is a diagram depicting the correspondence among the LUN 151, the pool 161, and address spaces of the storage drives 110, pages in the pool, and pages in the address spaces of the storage drives in the storage device 102.

At least one LUN 151 exists in the storage device 102, and is directly accessible to the host computer 103. The LUN 151 stores plaintext data supplied from the host computer 103. An address space indicated by an LBA is defined for the LUN 151. LBA represents a logical block address.

The host computer 103 designates an address in the LUN 151, and writes/reads host data into/from the storage device 102. The host data received from the host computer 103 and host data to be returned to the host computer 103 are non-compressed plaintext data. The plaintext data is stored into the LUN 151, and the address designated by the host computer 103 is allocated thereto. FIG. 3 illustrates plaintext data A 153A, plaintext data B 153B, and plaintext data C 153C.

The plaintext data is compressed by the storage controller 104 so as to be converted to compressed data. It is to be noted that elimination of a duplication may be performed in addition to or in place of the compression, and any other data conversion may be performed. An example of data compression will be given in the following explanation.

The compressed data is stored into media of the storage drives 110. FIG. 3 illustrates respective compressed data a 165A, compressed data b 165B, and compressed data c 165C of the plaintext data A 153A, the plaintext data B 153B, and the plaintext data C 153C.

The pool 161 is used to manage compressed data stored in the storage drives 110. An address space is defined for the pool 161. Compressed data is stored into the pool 161, and an address in the address space is allocated to the stored compressed data. Mapping between an address in the pool 161 and an address in the LUN 151 is managed in accordance with management information, which will be explained later.

In the configuration example in FIG. 3, an address space in the pool 161 is managed in units of page. A page is a preset address region of a prescribed size, and is created so as to be separated from other pages without overlapping the other pages. FIG. 3 illustrates two pages 163A and 163B. The compressed data is stored into either one of the pages, that is, the address region of either one of the pages is allocated to the compressed data. In the example in FIG. 3, the address region of the page 163A is allocated to the compressed data a 165A while the address region of the page 163B is allocated to the compressed data b 165B and the compressed data c 165C. It is to be noted that pages which are management units are not necessarily used.

In the configuration example in FIG. 3, a plurality of the storage drives 110 constitute a parity group, and an address of the parity group and an address in the pool 161 are managed in accordance with management information which will be explained later. FIG. 3 illustrates two parity groups 115A and 115B. Each parity group stores redundant data which is generated from the host data, in addition to the host data. The host data and the redundant data are distributedly stored into a plurality of the storage drives 110, so that host data can be recovered even if a failure occurs in any one of the storage drives 110 storing the host data.

A storage region in each parity group is also managed in units of page, as in the pool 161. A page size in a parity group matches a page size in the pool 161. FIG. 3 illustrates pages 173A and 173B. The pages 173A and 173B are allocated to pages 163A and 163B in the pool.

A start address and an end address of compressed data in the address spaces of the storage drives 110 are associated with a start address and an end address of the compressed data in the address space of the pool 161, respectively. Mapping between the address spaces of the storage drives 110 and the pool 161 is fixed. A start address and an end address of compressed data in the address space of the pool 161 are associated with a start address and an end address of non-compressed data in the address space of the LUN 151, respectively. These mappings are changed each time updated data is written.

The size of compressed data varies depending on the data pattern before compression. In order to store compressed data into the storage regions in the storage drives 110 without space, the data is placed from the front side of the storage regions. There is no guarantee that, when update writing is received, the size of new compressed data is consistent with that of old compressed data. Therefore, the storage controller 104 sets the state of the old data to garbage, and then, selects an arrangement area (addition area) for the new data. Both update data for updating host data stored in the LUN 151 and data to be added to the LUN 151 are stored into addresses in order from the first address of successive empty regions.

An addition area is selected from among pages in the pool 161 obtained by virtualizing the addresses of the virtualizing storage drives 110. The pool 161 is an addition address space. The storage controller 104 can optionally select a page as an addition area. In one embodiment of the present specification, the storage controller 104 selects, as an addition area, a normal storage drive more preferentially than storage drives such as failed storage drives or storage drives in which a data transfer is being performed, that are not in a normal status and are in prescribed states. Accordingly, an increase in the amount of data to be recovered during a data recovery process in a parity group, is suppressed.

In an addition method, the host data is additionally written into a physical address that is different from a logical address to which an access is made by the host computer accesses. It is to be noted that the addition method may be adopted in a storage device that adopts neither compression of data nor elimination of a duplication.

In the addition method, updated data is stored into a physical position that is different from the position of the data before the updating, and a consultation area in the pool 161, for the data stored in the LUN 151 is changed, whereby the data is updated. The size of compressed data depends on the content of the data before the compression. Thus, in order to enhance the efficiency in reducing data, compressed data is stored into storage drives (parity group) without space.

In the addition method, compressed data can be sequentially stored from an optional position in the address spaces of the storage drives. Thus, the addition method is suitable for a storage device having a data deleting function such as a compression function. In one embodiment of the present specification, the storage device 102 adopts the addition method. When data in the LUN 151 is updated or new data is written into the LUN 151 by host writing, the storage controller 104 stores the data into an unoccupied region in the pool 161, and changes a consultation area for the data in the LUN 151, so that data updating is accomplished.

In the addition method, the storage region of the old data is disabled as a result of addition of new data. Since the disabled region is empty, fragmentation of the empty region may be caused. For this reason, a storage device using the addition method, conducts garbage collection to collect fragmented unoccupied regions. It is to be noted that the technology of garbage collection in the addition method is widely known, and thus, the details thereof will be omitted.

An example in which the host computer 103 reads out compressed data stored in a parity group, will be explained. The host computer 103 transmits a plaintext data reading request with a designation of an address in the LUN 151, to the storage device 102. The storage controller 104 consults management information, and identifies an address in the pool 161 corresponding to the designated address.

The storage controller 104 reads out, from a parity group, compressed data in the identified address in the pool 161, and stores the read data into the memory 107. The storage controller 104 converts the compressed data to plaintext data by expanding the compressed data. The plaintext data is stored into the memory 107. The storage controller 104 returns the read plaintext data to the host computer 103.

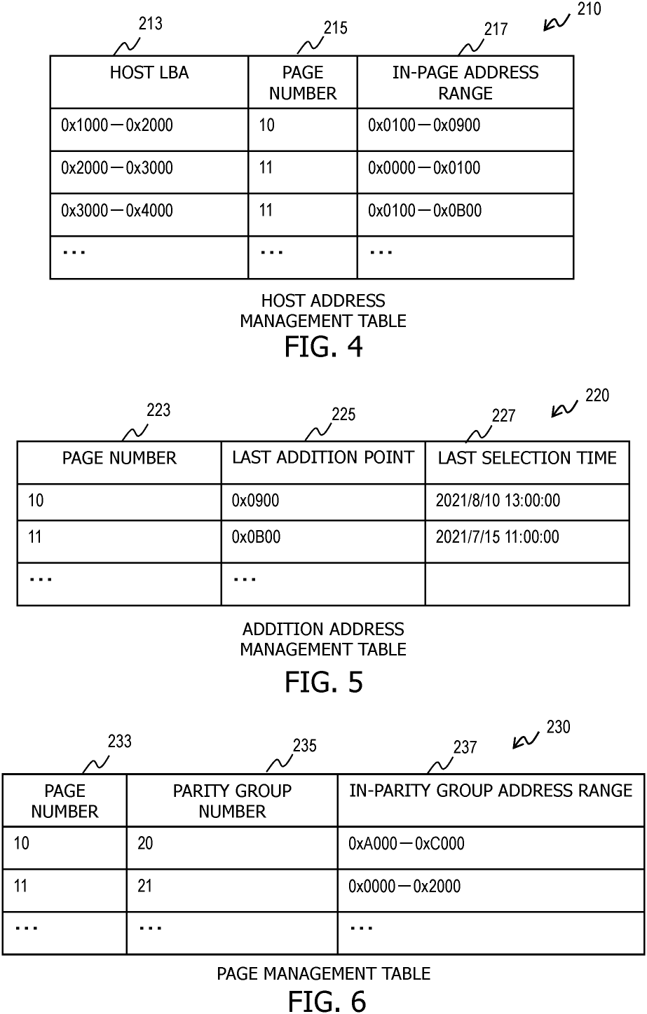

FIGS. 4 to 8 show some examples of management information held in the storage controller 104. The management information is stored in the storage drives 110, for example, and is loaded to the memory 107. FIG. 4 shows a configuration example of a host address management table 210. In the host address management table 210, mapping between an address in an LUN and an address in a pool is managed. The host address management table 210 shows a host LBA field 213, a page number field 215, and an in-page address range field 217.

The host LBA field 213 shows a storage address range of host data (user data) in the LUN. Addresses are indicated by LBA. The host LBA field 213 indicates an address range to which host data before compression is stored (which is allocated to host data before compression).

The page number field 215 shows numbers assigned to pages in a pool each storing compressed host data (allocated to compressed host data). The page numbers each identify a page in the pool 161. The in-page address range field 217 shows an address range in a page in which compressed host data is stored (which is allocated to compressed host data). The post-compression address range is narrower than the precompression address range.

FIG. 5 shows a configuration example of an addition address management table 220. The addition address management table 220 manages unoccupied regions in pages in the pool. As described above, the storage controller 104 stores new compressed data into an unoccupied region following the last writing position.

The addition address management table 220 includes a page number field 223, a last addition point field 225, and a last selection time field 227. The page number field 223 indicates a page number in the pool. The last addition point field 225 indicates an end address of the last written (added) data in each page. The last addition point field 225 indicates the addition time of the last data in each page.

In one embodiment of the present specification, the storage controller 104 selects a page to which received writing data is added, on the basis of a time indicated by the last selection time field 227. For example, a page the last selection time of which is the oldest is selected. In order to inhibit a particular storage drive from becoming a performance bottleneck, the storage controller 104 evenly uses the mounted storage drives. In one method for evenly selecting pages as addition areas, reference to a time is made. In another example, a page for storing new host data may be selected by round robin, or a page having the largest unoccupied capacity may be selected.

FIG. 6 depicts a configuration example of a page management table 230. The page management table 230 manages mapping between the address space in the pool 161 and a physical address space of a parity group (storage drives). The page management table 230 includes a page number field 233, a parity group number field 235, and an in-parity group address range field 237.

The page number field 233 indicates a number assigned to a page in the pool 161. The parity group number field 235 shows a number assigned to a parity group associated with the page, and shows a number assigned to a parity group including a storage region to be mapped with the page. The in-parity group address range field 237 shows a storage region, in a parity group, to be mapped with the page.

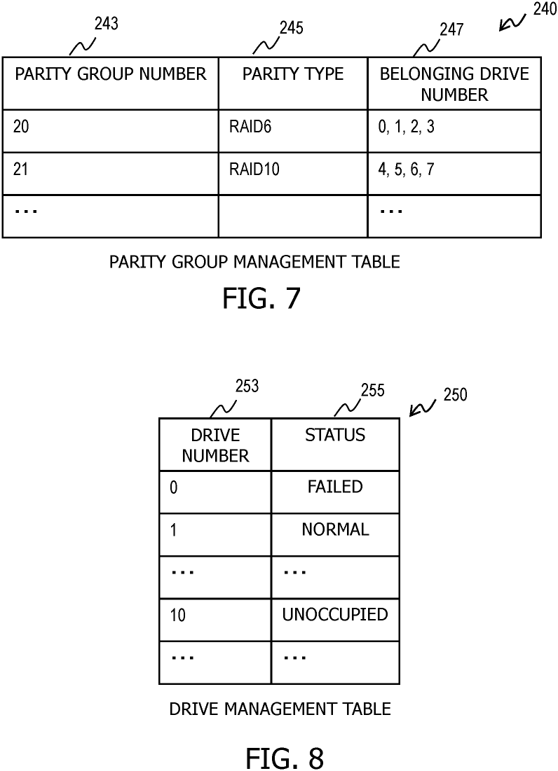

FIG. 7 shows a configuration example of a parity group management table 240. The parity group management table 240 includes a parity group number field 243, a parity type field 245, and a belonging drive number field 247. The parity group number field 243 indicates a number for identifying a parity group.

The parity type field 245 shows the parity type of a parity group. The parity type can show a general RAID such as RAID5 or RAID6, but also can show a technical parity type such as a distributed RAID. In one embodiment of the present specification, a virtual address (page) associated with a belonging drive is properly selected not on the basis of the parity type, so that the recovery time period is suppressed, which will be explained later.

The belonging drive number field 247 indicates numbers assigned to respective storage drives belonging to each parity group. A drive number is given to identify a storage drive. Each parity group consists of a plurality of the storage drives 110. Each of the storage drive can belong to a plurality of parity groups.

FIG. 8 illustrates a configuration example of a drive management table 250 in which the storage drives 110 are managed. The drive management table 250 includes a drive number field 253 and a status field 255. The drive number field 253 shows numbers assigned to the respective storage drives 110. The status field 255 shows the respective statuses of the storage drives 110. “Failed” indicates occurrence of a failure in the storage drive. “Normal” indicates that the storage drive is normally operating, and is capable of normally performing I/O. “Unoccupied” indicates that a storage drive corresponding to the storage drive number is not mounted.

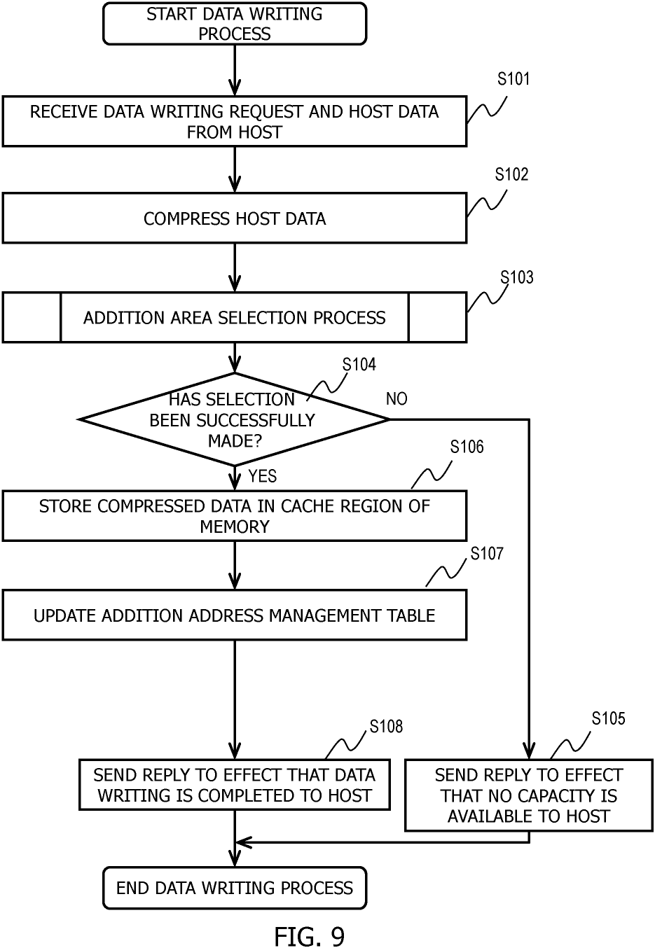

Hereinafter, some examples of processes that are executed by the storage controller 104 will be explained. FIG. 9 shows a flowchart of an example of a writing process of host data received from a host computer. The host data is for new writing of writing new data into an address in which no write data is stored in an LUN, or for update writing of updating stored data.

The storage controller 104 receives, from the host computer 103, a data writing request and host data (write data) (S101). Specifically, the processor 106 stores the host data received via the host interface 108, into a buffer region in the memory 107.

Next, the processor 106 compresses the host data, and stores the compressed data into a buffer region in the memory 107 (S102). Further, the processor 106 executes a process of selecting an addition area of the compressed data in the pool 161 (S103). The details of the addition area selection process S103 will be explained later.

In a case where an addition area in the pool 161 is not selected (S104: NO), the processor 106 sends a reply to the effect that there is no empty region for storing the host data, to the host computer 103 (S105).

In a case where an addition area in the pool 161 is selected at step S104 (S104: YES), the processor 106 stores the compressed data into a cache region in the memory 107 (S106). Further, the processor 106 updates the addition address management table 220. Specifically, the processor 106 updates entry information on the page in which the addition has been performed, according to the page, the addition address in the page, and the time of the addition. Next, the processor 106 sends a reply to the effect that the writing process of the host data is completed, to the host computer 103 (S108).

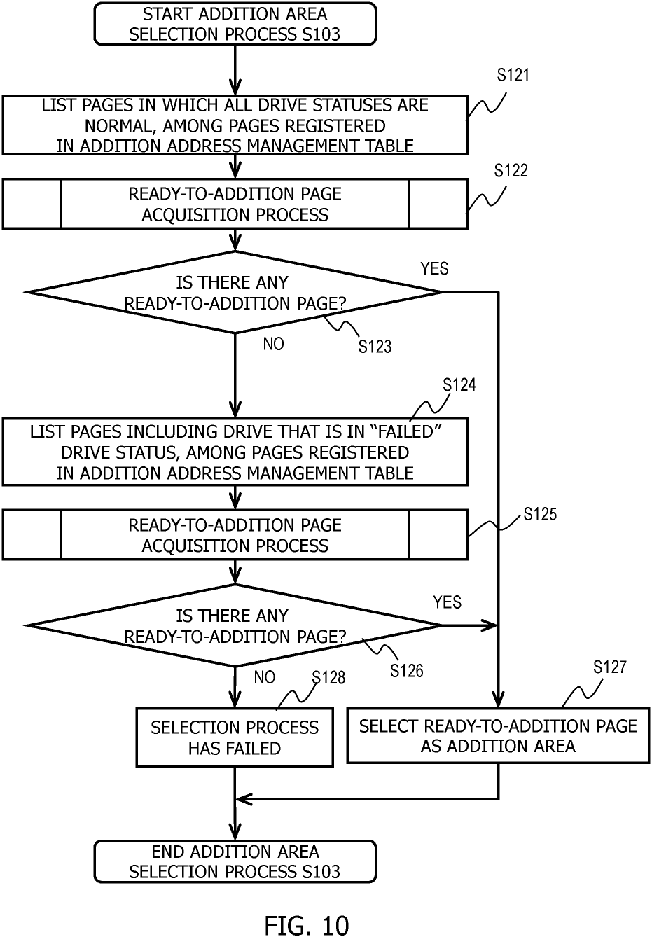

FIG. 10 is a flowchart of an example of the addition area selection process S103 in the flowchart of FIG. 9. The processor 106 lists pages in which all the storage drives are in a “normal” status, among pages registered in the addition address management table 220 (S121). “Normal” storage drives 110 are drives that are mounted on the drive casing 105, and that are normally operating. A parity group consisting of “normal” storage drives only is a normal status parity group. A normal status parity group can normally store the host data and a redundant code, so that a data recovery process is unnecessary afterward.

For example, the processor 106 selects a drive number for which a value “normal” is set in the status field 255 by consulting the drive management table 250. The processor 106 selects, from the parity group number field 243, a number assigned to a parity group consisting of the drives selected in the belonging drive number field 247, by consulting the parity group management table 240, and then, lists the selected drives.

Next, the processor 106 executes a ready-to-addition page acquisition process (S122). The details of the ready-to-addition page acquisition process S122 will be explained later. In a case where a ready-to-addition page is acquired (S123: YES), the processor 106 selects the acquired ready-to-addition page as an addition area of the host data, and sends a reply indicating the selection result (S127).

In a case where a ready-to-addition page is not acquired at step S123 (S123: NO), the processor 106 lists pages including the storage drives 110 that are in a “failed” status, among pages registered in the addition address management table 220 (S124). A parity group including a “failed” storage drive is an abnormal status parity group, and requires a data recovery process. For example, the processor 106 selects, from the parity group number field 243, numbers assigned to parity groups excluded from the selection at step S121 by consulting the parity group management table 240, and lists the selected numbers.

Next, the processor 106 executes a ready-to-addition page acquisition process (S125). The details of the ready-to-addition page acquisition process S125 will be explained later. In a case where a ready-to-addition page is acquired (S126: YES), the processor 106 selects the acquired ready-to-addition page as an addition area of the host data, and sends a reply indicating the selection result (S127).

In a case where a ready-to-addition page is not acquired at step S126 (S126: NO), the processor 106 determines that the addition area selection process has failed, and sends a reply indicating the failure (S128).

As explained so far, a page consisting of storage regions of normal storage drives only is preferentially selected, so that a load of a data recovery process can be reduced. In addition, in a case where unoccupied regions are insufficient in a page consisting of normal storage drives only, an addition area candidate is selected from among pages including abnormal storage drives, so that the error frequency in host writing can be reduced.

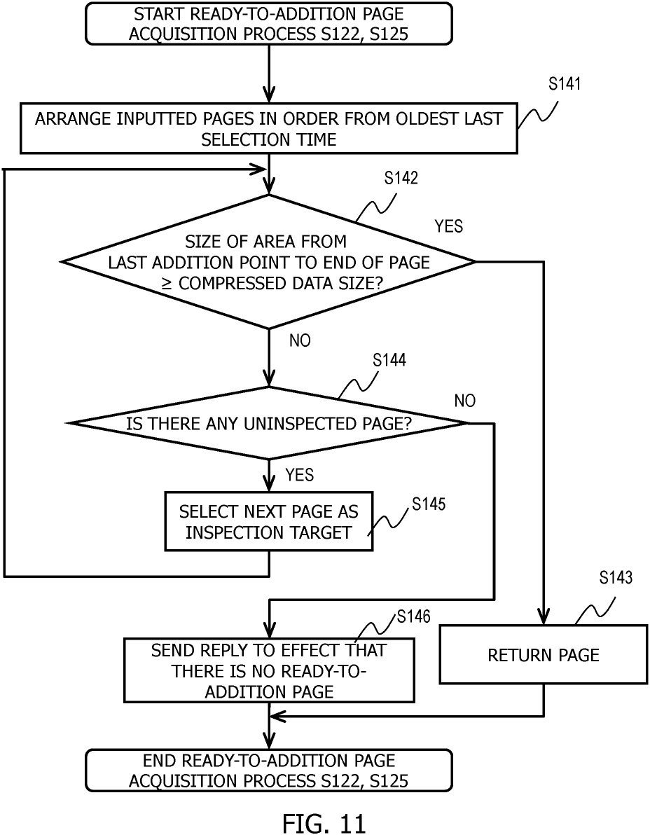

FIG. 11 is a flowchart of an example of the ready-to-addition page acquisition process S122, S125 in the flowchart of FIG. 10. The processor 106 arranges the (numbers assigned to the) inputted pages in the order from the oldest last selection time (S141). For example, the processor 106 acquires time information on each of the inputted pages from the last selection time field 227 in the addition address management table 220, and arranges the pages in the order from the oldest time.

Next, the processor 106 selects the first page of uninspected pages, and compares a vacant size in the page with the size of the compressed host data (S142). The vacant size in the page is the size of an area from the last addition position in the page to the end of the page. The last addition page in the page is acquired from the last addition position filed 225 in the addition address management table 220. A page size is previously set to a prescribed value, and the end of the page is also set to a prescribed value.

In a case where the size of the area from the last addition position in the page to the end of the page is equal to or larger than the size of the compressed data (S142: YES), the processor 106 returns the page (S143). In a case where the size of the area from the last addition position in the page to the end of the page is smaller than the size of the compressed data (S142: NO), the processor 106 determines whether there is any uninspected page (S144).

In a case where there is no uninspected page (S144: NO), the processor 106 sends a reply to the effect that there is no ready-to-addition page (S146). In a case where there is any uninspected page (S144: YES), the processor 106 selects, as an inspection target, the next page, that is, a page the last selection time is the oldest of the uninspected pages (S145). Then, the process returns to step S142.

As a result of this process, a page having a vacant size that satisfies a condition for storing host data is selected. Addition area candidate pages are selected in the order from the oldest last start time, so that accesses to storage drives can be uniformized.

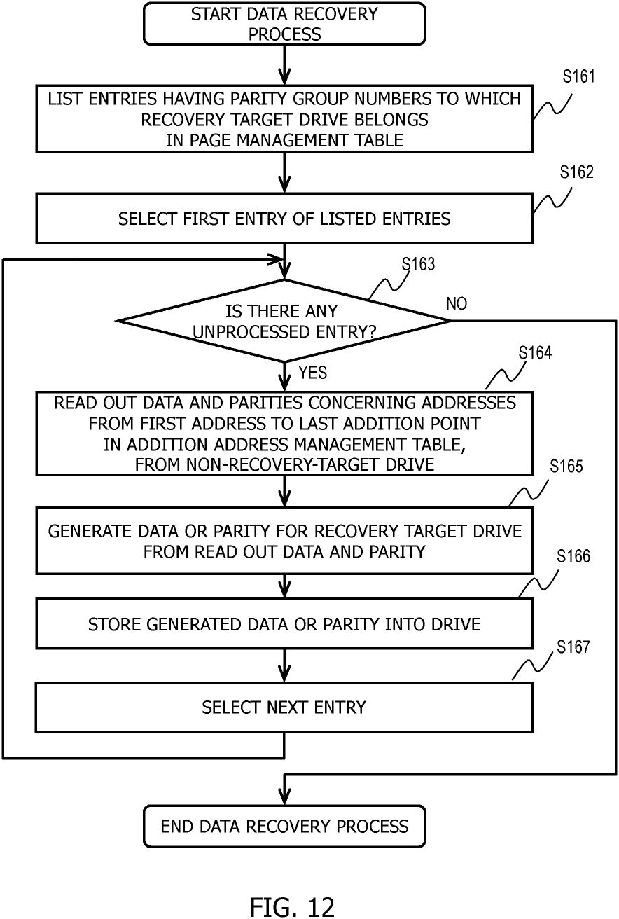

FIG. 12 is a flowchart of an example of the data recovery process. In the data recovery process, data in a storage derives is recovered from another storage drive in a parity group. The processor 106 lists, from the page management table 230, entries (pages) having a number assigned to a parity group to which a storage drive as a recovery target belongs (S161).

Next, the processor 106 selects the first entry (page) of the listed entries (pages) (S162). The processor 106 determines whether there is any unprocessed entry (S163). In a case where there is no unprocessed entry (S163: NO), the present flow is ended.

In a case where there is an unprocessed entry (S163: YES), the processor 106 reads out data and a parity from a storage drive that is not a recovery target, for the address range, in the selected page, from the first address to the position of the addition address management table 220 indicated by the last addition point field 225 (S164).

Next, the processor 106 generates data and a parity for a recovery target storage drive, from the read data and the read parity (S165). The processor 106 stores the generated data or parity into the recovery target storage drive (S166). Thereafter, the processor 106 selects the next entry (page) (S167). Then, the process returns to step S163.

### Second Embodiment

An explanation of another embodiment of the present specification will be given below. In one embodiment of the present specification, storage drives are reused when the entirety or a part of the storage device is updated. For example, storage drives are reused when a storage device including a drive casing is updated or a drive casing alone is updated. Hereinafter, a data transfer during updating of a storage device will be explained. When a storage drive that is a transfer destination is reused, the hardware cost for updating a storage device can be suppressed. The differences from the first embodiment will be mainly explained below.

A data transfer is accomplished by transferring storage drives in a transfer source storage device one by one to a transfer destination storage device. In a case where data writing into a parity group is received during the transfer, a storage controller registers the data as a differential rebuild target. The differential rebuild target data is data to be recovered after the transfer. That is, the differential rebuild target data is to be written into a parity group, but has not been written into the parity group yet.

Data about the differential rebuild target is generated after the transfer of a storage drive, and is written into the storage drive, so that a task can be continued in the transfer destination. To a parity group for which the transfer has been performed, data writing can be performed through a storage controller of the transfer destination storage device. In one embodiment of the present specification, the priority level of addition to a parity group in which a transfer is being performed is set to be low. Accordingly, an increase in differential rebuild target data can be suppressed.

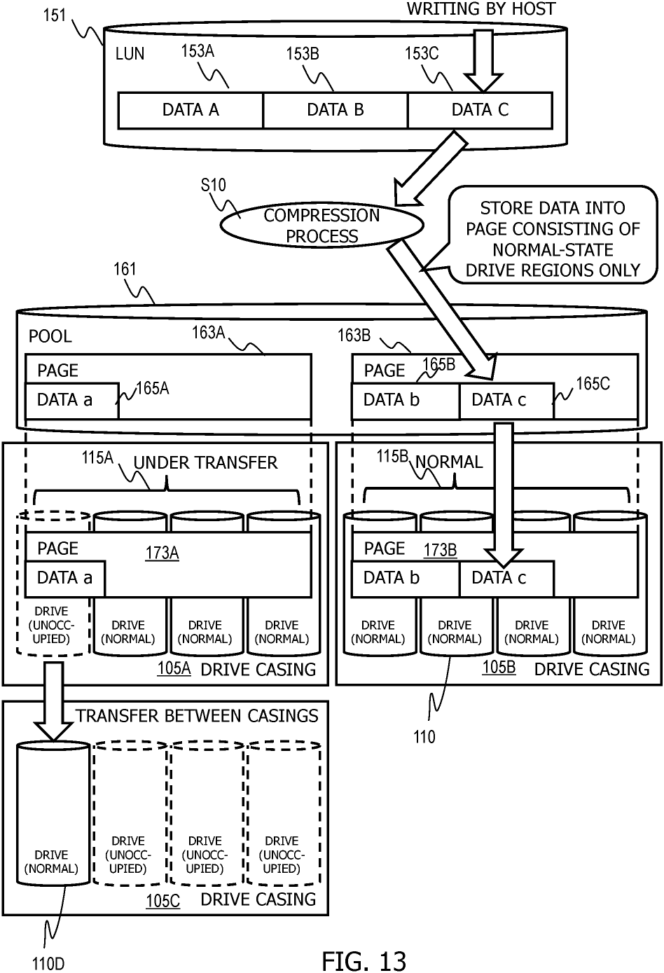

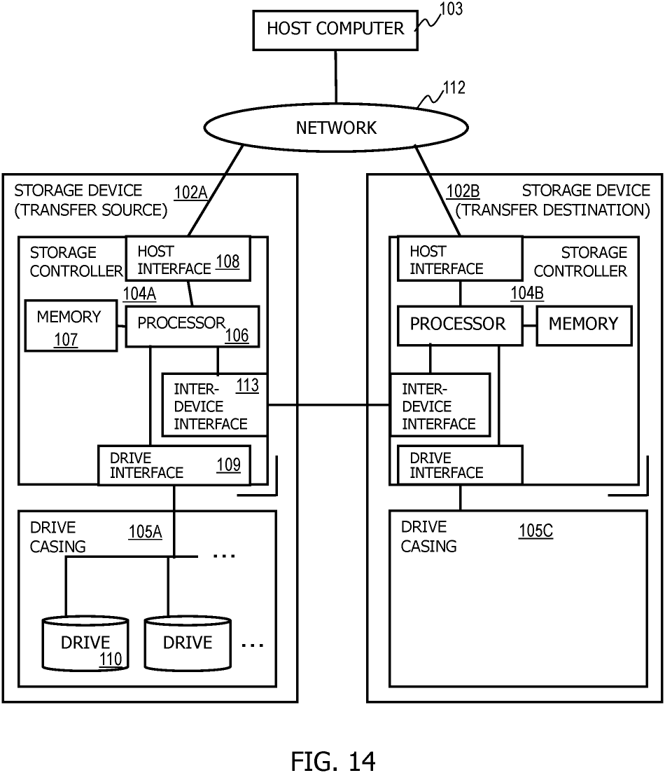

FIG. 13 roughly depicts a method of selecting an addition area of host data according to the second embodiment. The page 173A of the parity group 115A housed in a drive casing 105A is allocated to the page 163A in the pool. The page 173B of the parity group 115B housed in a drive casing 105B is allocated to the page 163B in the pool.

The parity group 115A in the drive casing 105A is under a transfer, and the storage drives in the drive casing 105A are transferred to a new drive casing 105C. FIG. 13 illustrates a storage drive 110D that is transferred from the drive casing 105A to the drive casing 105C. A status “unoccupied” is defined as the storage drive status of the drive casing at the transfer source after the transfer.

In a case where there are a parity group in which a transfer has not been performed or has been performed and a parity group in which a transfer is being performed, the storage controller 104 preferentially selects, as an addition area candidate, a page in which a transfer has not been performed or has been performed. Accordingly, data writing to parity groups is reduced during the transfer, and an increase in differential build targets after the transfer is suppressed. A parity group in which a transfer has not been performed or has been performed is in a normal status for which differential rebuild is unnecessary. A parity group in which a transfer is being performed is in an abnormal status for which differential rebuild is necessary.

FIG. 14 shows a hardware configuration example of one embodiment of the present specification. FIG. 14 illustrates a storage device 102A which is a data transfer source and a storage device 102B which is a data transfer destination. The storage controllers 104A and 104B have the same configuration. Components of the storage controller 104A of the storage device 102A are denoted by reference numerals for an illustrative purpose. Besides the components in the storage controller of the first embodiment, an inter-device interface 113 with which communication between storage devices can be performed is installed. Data exchange for a data transfer between storage devices is performed via the inter-device interface 113.

The storage device 102A includes the drive casing 105A. The drive casing 105A houses a plurality of the storage drives 110. In the following example, the drive casing 105A accommodates a plurality of parity groups. The storage device 102A includes the drive casing 105B. FIG. 14 shows the drive casing 105B in a state where the storage drives 110 have not been transferred from the drive casing 105A.

Before completion of a data transfer, the transfer source storage device 102A receives an I/O request from the host computer 103, and deals with the request. After the transfer, the transfer destination storage device 102B receives an I/O request from the host computer 103, and deals with the request. In this manner, the transfer destination storage device 102B executes a differential rebuild process after the transfer.

It is to be noted that drive casings are installed in respective storage devices in the configuration example depicted in FIG. 14. In another case, a drive casing may be disposed outside the storage devices, and may be accessible to the storage devices.

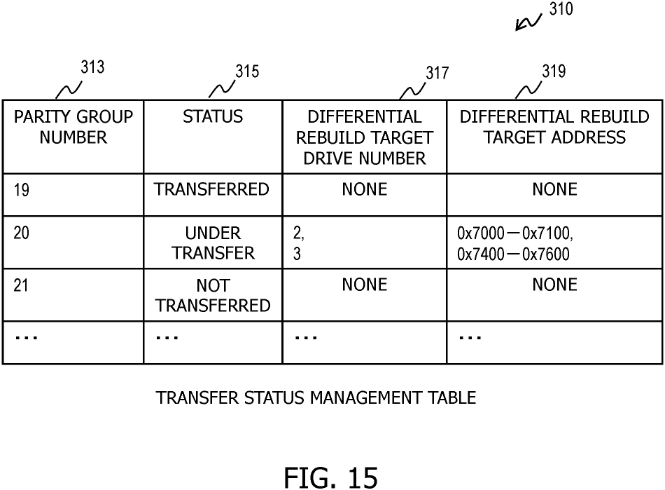

FIG. 15 depicts a configuration example of a transfer status management table including storage device management information. The whole of the management information is shared by respective storage controllers 104A and 104B of the two storage devices 102A and 102B. A transfer status management table 310 manages the status of a parity group concerning a data transfer.

In the example in FIG. 15, the transfer status management table 310 includes a parity group number field 313, a status field 315, a differential rebuild target drive number field 317, and a differential rebuild target address field 319. The parity group number field 313 indicates a number for identifying a parity group. The status field 315 indicates the respective statuses of parity groups. Specifically, the status field 315 indicates that a transfer has not been transferred, has been transferred, or is being performed in each parity group.

To a parity group in which a transfer has not been performed or has been performed, normal data writing can be performed. The transfer source storage controller 104A receives a writing request from the host computer 103. The storage controller 104A can write data, in a normal manner, to a parity group in which a transfer has not been performed.

A request for data writing into a parity group in which a transfer has been performed, is provided from the storage controller 104A to the storage controller 104B. That is, the host data as well as a writing request is transmitted from the storage controller 104A to the storage controller 104B. The storage controller 104B compresses the host data, and adds the compressed data to the parity group.

The differential rebuild target drive number field 317 indicates a number assigned to a storage drive which is a target of a differential rebuild process by the storage controller 104B. The differential rebuild target address field 319 indicates an address of a target of a differential rebuild process by the storage controller 104B.

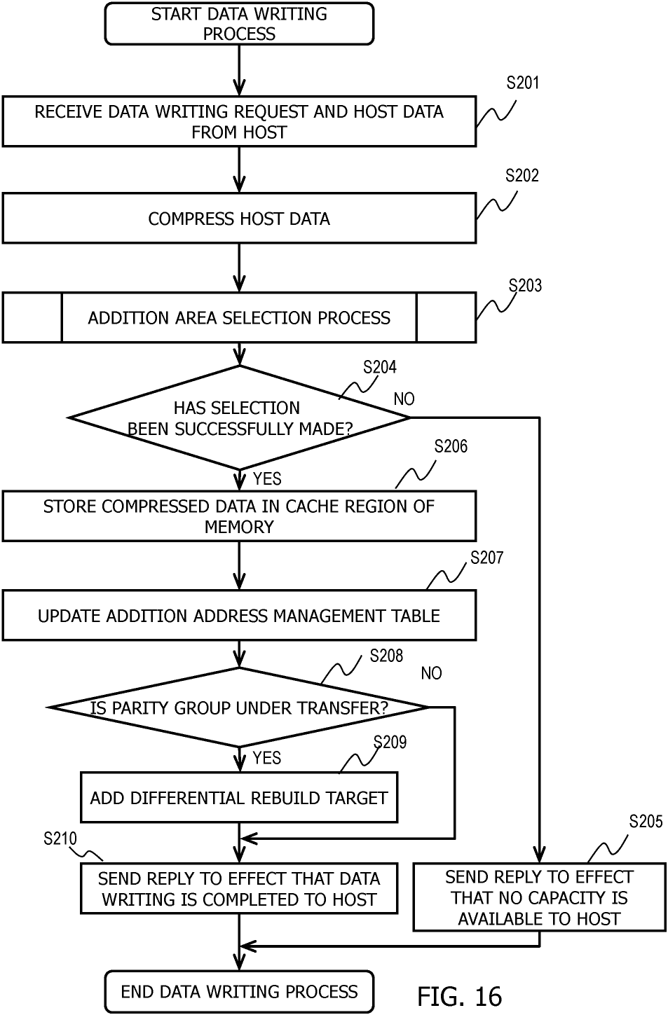

FIG. 16 shows a flowchart of an example of a writing process of host data received from a host computer according to one embodiment of the present specification. The storage controller 104A receives a data writing request and host data from the host computer 103 (S201). Specifically, the processor 106 of the storage controller 104A stores the host data received via the host interface 108, into a buffer region in the memory 107.

Next, the processor 106 of the storage controller 104A compresses the host data, and stores the compressed host data into a buffer region in the memory 107 (S202). Further, the processor 106 executes a process of selecting an addition area of the compressed data (S203). The details of the addition area selection process S203 will be explained later.

In a case where an addition area is not selected (S204: NO), the processor 106 of the storage controller 104A sends a reply to the effect that there is no empty region for storing the host data, to the host computer 103 (S205).

In a case where an addition area is selected at step S204 (S204: YES), the processor 106 of the storage controller 104A stores the compressed data into a cache region in the memory 107 (S206). Further, the processor 106 updates the addition address management table 220.

Next, the processor 106 of the storage controller 104A determines whether the addition area is in a parity group in which a transfer is being performed (S208). In a case where the addition area is in a parity group in which a transfer has not been performed or has been performed (S208: NO), the processor 106 of the storage controller 104A sends a reply to the effect that the writing process of the host data is completed to the host computer 103 (S210).

In a case where the addition area is in a parity group in which a transfer is being performed (S208: YES), the processor 106 of the storage controller 104A adds a differential rebuild target to the transfer status management table 310 (S209). Thereafter, the processor 106 of the storage controller 104A sends a reply to the effect that the writing process of the host data is completed to the host computer 103 (S210).

The transfer source storage controller 104A writes the data into a storage drive 110 that has not been transferred in the parity group under the transfer. The transfer destination storage controller 104B receives an address and data to be written from the transfer source storage controller 104A, and writes the data into a transferred storage drive 110.

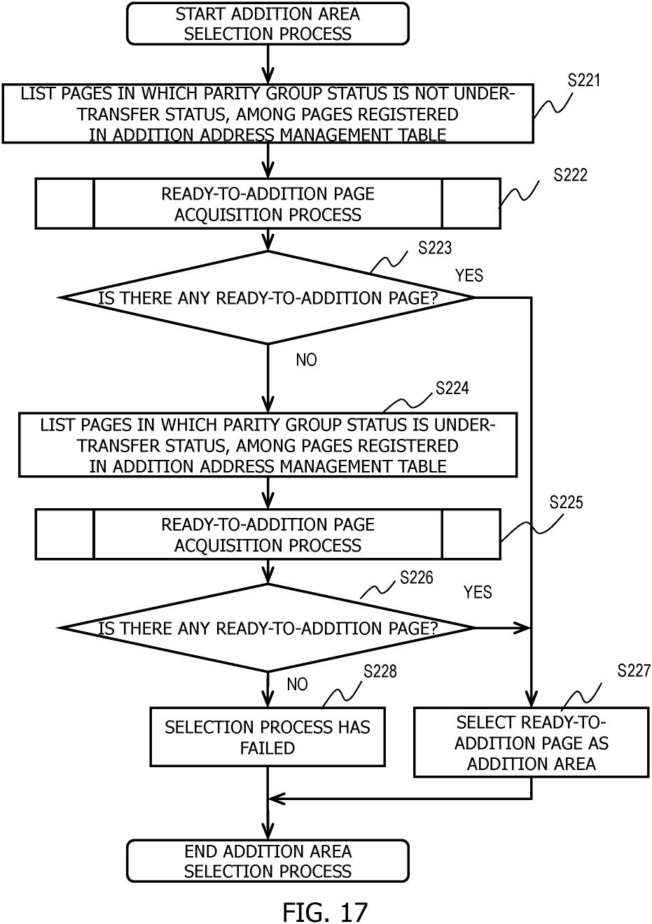

FIG. 17 is a flowchart of an example of the addition area selection process S203 in the flowchart of FIG. 16. In the following explanation, it is assumed that all the storage drives are in a normal or unoccupied status.

The processor 106 of the transfer source storage controller 104A lists pages in which a parity group status is not an “under transfer” status, among pages registered in the addition address management table 220 (S221). Specifically, the processor 106 selects a number assigned to a parity group for which the value in the status field 315 indicates “transferred” or “not transferred,” by consulting the transfer status management table 310. The processor 106 gets to know a number assigned to a page belonging to the selected parity group, by consulting the page management table 230.

Next, the processor 106 executes a ready-to-addition page acquisition process (S222). The ready-to-addition page acquisition process S222 is similar to the ready-to-addition page acquisition process that has been explained in the first embodiment. In a case where a ready-to-addition page is acquired (S223: YES), the processor 106 selects the acquired ready-to-addition page as an addition area of the host data, and sends a reply indicating the selection result (S227) .

In a case where a ready-to-addition page is not acquired at step S223 (S223: NO), the processor 106 lists pages in which a parity group status is an “under transfer” status, among pages registered in the addition address management table 220 (S224).

Next, the processor 106 executes a ready-to-addition page acquisition process (S225). In a case where a ready-to-addition page is acquired (S226: YES), the processor 106 selects the acquired ready-to-addition page as an addition area of the host data, and sends a reply indicating the selection result (S227).

In a case where a ready-to-addition page is not acquired at step S226 (S226: NO), the processor 106 determines that the addition area selection process has failed, and sends a reply indicating the failure (S228).

As explained so far, a page in a parity group in which a transfer has not been performed or has been performed is more preferentially selected than a page in a parity group in which a transfer is being performed. Accordingly, a load of the differential rebuild process can be reduced. In addition, in a case where unoccupied regions are insufficient in pages of parity groups in which a transfer has not been performed and a transfer has been performed, an addition area candidate is selected from among pages in parity groups in each of which a transfer is being performed, so that the error frequency in host writing can be reduced.

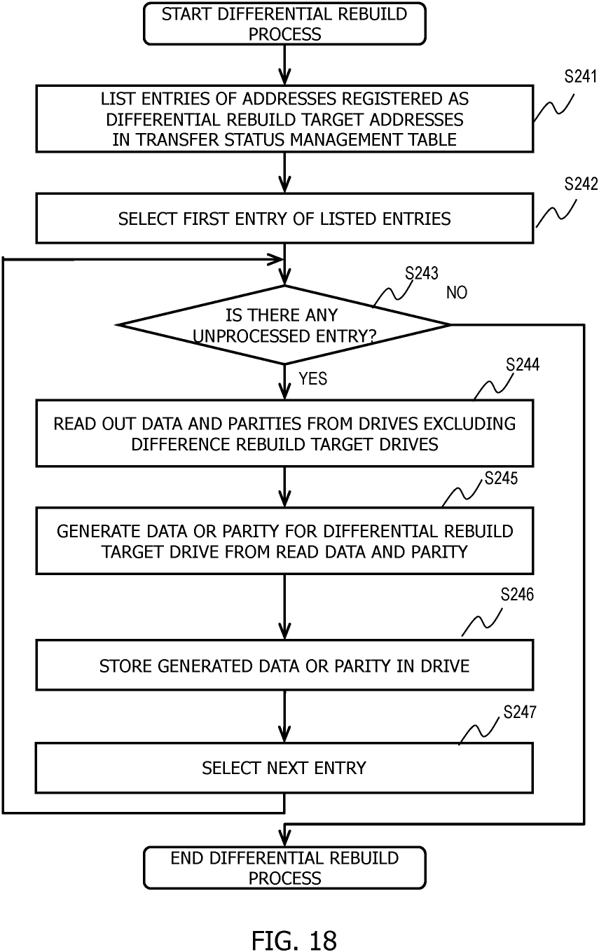

FIG. 18 shows a flowchart of an example of the differential rebuild process. This process is executed by the storage controller 104B of the transfer destination storage device 102B. The processor 106 lists entries of addresses registered in the differential rebuild target address field 319, from the transfer status management table 310 (S241).

Next, the processor 106 selects the first entry of the listed entries (S242). The processor 106 determines whether there is any unprocessed entry (S243). In a case where there is no unprocessed entry (S243: NO), the present flow is ended.

In a case where there is an unprocessed entry (S243: YES), the processor 106 reads out a parity and data from storage drives excluding storage drives which are differential rebuild targets (S244). Next, the processor 106 generates a parity or data for a storage drive which is a differential rebuild target, from the read parity and data (S245). The processor 106 stores the generated parity or data into the storage drive which is a differential rebuild target (S246). Thereafter, the processor 106 selects a next entry (S247). Then, the process returns to step S243.

### Third Embodiment

Hereinafter, still another embodiment of the present specification will be explained. In one embodiment of the present specification, in a case where there are a parity group in which a data transfer is being performed and a failed drive, a page in the parity group in which a data transfer is being performed is more preferentially selected, as an addition area candidate, than a page in the failed drive. As in the first embodiment, a page consisting of normal storage drives only is more preferentially selected, as an addition area, than a page including the failed storage drive. In addition, as in the second embodiment, a page in a parity group in which a transfer has not been performed or has been performed is more preferentially selected, as an addition area, than a page in a parity group in which a transfer is being performed.

An operation of recovering and transferring data varies depending on when a failure storage drive occurs. When a failure occurs in a storage drive that has not been transferred, a transfer is conducted after the failure storage drive is exchanged and data is recovered. When a failure occurs during a transfer, the failure storage drive is exchanged and a data recovery process is executed after the transfer. When a failure occurs after a transfer, the failure storage drive is exchanged, and then, a data recovery process is executed (first embodiment).

There is a possibility that a failure storage drive is transferred after a recovery. There is a possibility that the number of data accesses made to a failure storage drive is greater than the number of accesses made to a storage drive that is being transferred. For this reason, a page in a storage drive that is being transferred is preferentially selected than a page in a failed storage drive, so that the amount of the following processes can be reduced.

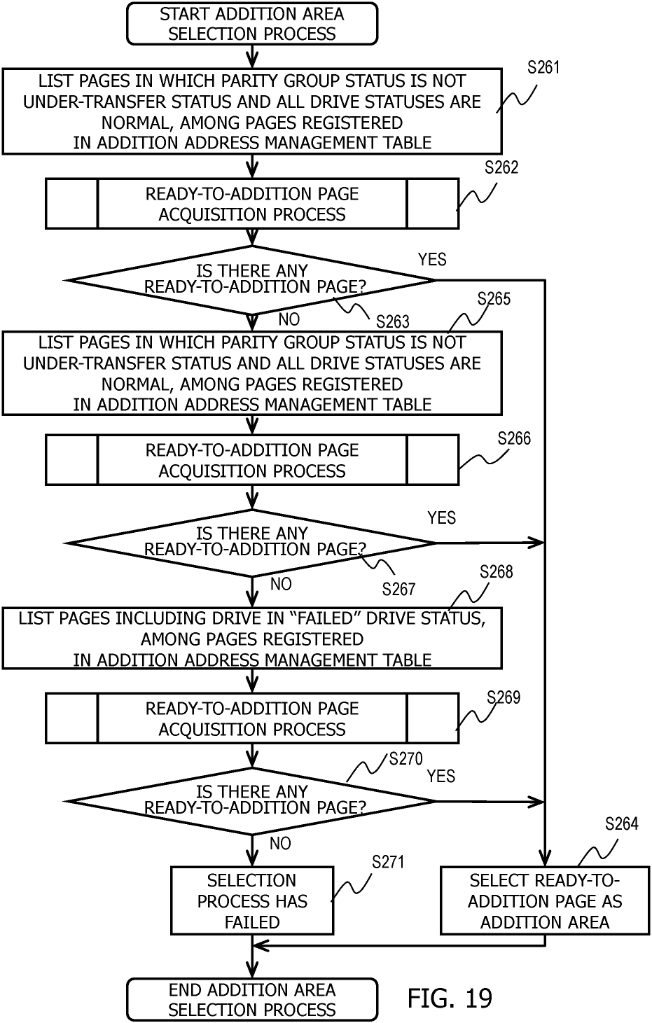

FIG. 19 shows a flowchart of an example of the addition area selection process. The present process is executed by the transfer source storage controller 104A. The processor 106 lists pages in which a parity group status is not an under transfer status and all the storage drives are in a normal status, among pages registered in the addition address management table 220 (S261).

The status of a parity group can be obtained with reference to the transfer status management table 310, and the status of a storage drive can be obtained with reference to the drive management table 250. A storage drive belonging to a parity group can be obtained with reference to the parity group management table 240. The relation between a parity group and a page can be obtained with reference to the page management table.

Next, the processor 106 executes a ready-to-addition page acquisition process on the listed pages (S262). The ready-to-addition page acquisition process is similar to the process that has been explained in the first embodiment. In a case where a ready-to-addition page is acquired (S263: YES), the processor 106 selects the ready-to-addition page as an addition area (S264).

In a case where no ready-to-addition page is acquired (S263: NO), the processor 106 lists pages in which a parity group status is an under transfer status and all drive statuses are in a normal status, among the pages registered in the addition address management table 220 (S265). Next, the processor 106 executes the ready-to-addition page acquisition process on the listed pages (S266). In a case where a ready-to-addition page is acquired (S267: YES), the processor 106 selects the ready-to-addition page as an addition area (S264).

In a case where no ready-to-addition page is acquired (S267: NO), the processor 106 lists pages in a parity group including a “failed” storage drive, among pages registered in the addition address management table 220 (S268). Next, the processor 106 executes a ready-to-addition page acquisition process on the listed pages (S269).

In a case where a ready-to-addition page is acquired (S270: YES), the processor 106 selects the ready-to-addition page as an addition area (S264). In a case where no ready-to-addition page is acquired (S270: NO), the processor 106 determines that the addition area selection process has failed, and sends a reply indicating the failure (S271).

Next, another method of the addition area selection process will be explained. In one embodiment of the present specification, a page in a parity group in which a transfer has been performed is most preferentially selected, and a page in a parity group for which a shorter time period is left before a transfer is more preferentially selected, among pages in parity groups in which a transfer has not been performed, during the addition area selection process that has been explained in the second embodiment. As a result, the amount of communication between a transfer source storage device and a transfer destination storage device can be reduced.

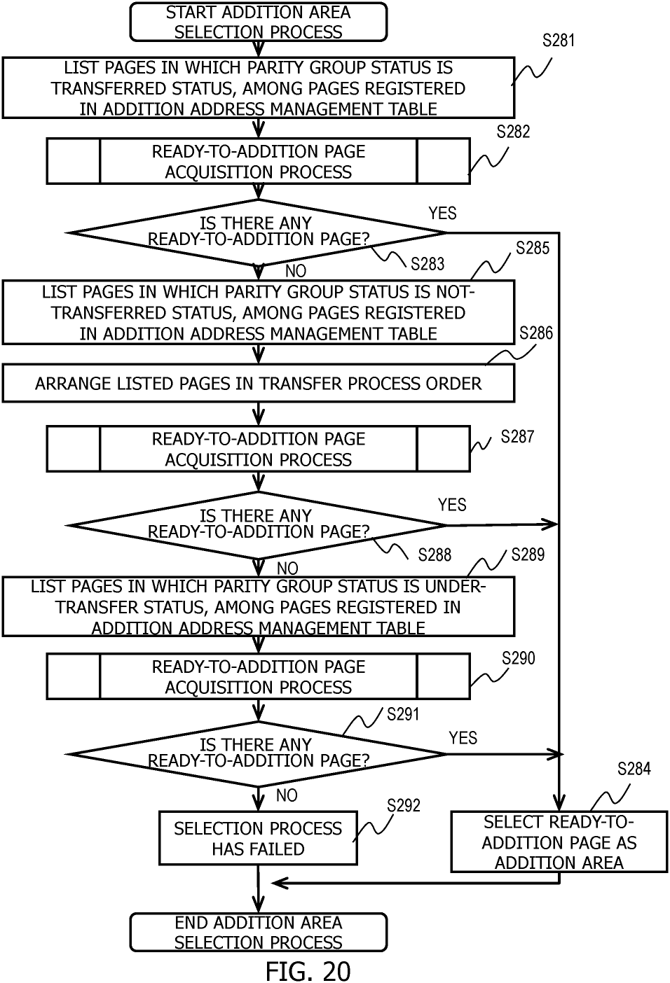

FIG. 20 shows a flowchart of another example of the addition area selection process. The present process is executed by the transfer source storage controller 104A. The processor 106 lists pages in which a parity group status is a transferred status, among pages registered in the addition address management table 220 (S281). Next, the processor 106 executes a ready-to-addition page acquisition process on the listed pages (S282).

In a case where a ready-to-addition page is acquired (S283: YES), the processor 106 selects the ready-to-addition page as an addition area (S284). In a case where no ready-to-addition page is acquired (S283: NO), the processor 106 lists pages in which a parity group status is a not-transferred status, among pages registered in the addition address management table 220 (S285). Further, the processor 106 arranges the listed pages in a transfer process order (S286). The transfer order of parity groups is managed in accordance with management information (not depicted).

The processor 106 sequentially selects the arranged pages from the front side, and executes a ready-to-addition page acquisition process on the selected page (S287). In a case where a ready-to-addition page is acquired (S288: YES), the processor 106 selects the ready-to-addition page as an addition area (S284). In a case where no ready-to-addition page is acquired (S288: NO), the processor 106 lists pages in which a parity group status is an under transfer status, among pages registered in the addition address management table 220 (S289).

Next, the processor 106 executes a ready-to-addition page acquisition process on the listed pages (S290). In a case where a ready-to-addition page is acquired (S291: YES), the processor 106 selects the ready-to-addition page as an addition area (S284). In a case where no ready-to-addition page is acquired (S291: NO), the processor 106 determines that the addition area selection process has failed, and sends a reply indicating the failure (S292).

It is to be noted that the present invention is not limited to the aforementioned embodiments, and encompasses various modifications. For example, the aforementioned embodiments have been explained in detail in order to explain the present invention in an easy-to-understand manner. The present invention is not necessarily limited to an embodiment having all the explained configurations. In addition, a part of the configuration of any one of the embodiments can be substituted by a configuration of another one of the embodiments. Moreover, a configuration of any one of the embodiments can be added to a configuration of another one of the embodiments. Furthermore, any other configuration can be added to a part of the configuration of each of the embodiment, or such a part can be deleted or substituted by another configuration.

The aforementioned configurations, functions, and processing units, etc., may be implemented by hardware by designing some or all thereof on an integrated circuit, for example. Also, the aforementioned configurations, functions, etc. may be implemented by software by a processor interpreting programs for implementing the functions, and executing the programs. Information on a program, a table, a file, etc., for implementing the functions can be put in a storage such as a memory, a hard disk, a solid state drive (SSD), or a recording medium such as an IC card or an SD card.

Control lines or information lines that are considered to be necessary to give an explanation are illustrated, but not all the control lines or information lines in a product are illustrated. It may be considered that almost all the configurations are actually connected to each other.

What is claimed is:

1. A storage device comprising:
a storage controller that accepts access made by a host; and
a plurality of storage drives that each store host data, wherein
the plurality of storage drives include a plurality of parity groups,
the storage controller manages
a logical volume to which the host makes an access and which manages host data,
an addition address space which is mapped with the logical volume and to which host data is added, and
a physical address space in the plurality of storage drives, the physical address space being mapped with the addition address space,
in the addition address space, different address regions are allocated to the respective parity groups,
in the addition address space, an unoccupied address region is selected as an addition area of host data supplied from the host, and
as the addition area, a region mapped to a normal status parity group in which data recovery is unnecessary is more preferentially selected than a region allocated to an abnormal status parity group in which data recovery is necessary.

2. The storage device according to claim 1, wherein
the abnormal status parity group is a parity group including a failed storage drive, and
the normal status parity group is a parity group consisting of normal storage drives only.

3. The storage device according to claim 1, wherein
the abnormal status parity group is a parity group in which a data transfer is being performed, and
the normal status parity group is a parity group in which a data transfer has not been performed or has been performed.

4. The storage device according to claim 2, wherein
the storage controller
more preferentially selects, as the addition area, a parity group in which a data transfer has not been performed or has been performed than a parity group in which a data transfer is being performed, and
more preferentially selects, as the addition area, the parity group in which a data transfer is being performed than a parity group including the failed storage drive.

5. The storage device according to claim 3, wherein
the storage controller more preferentially selects, as the addition area, among parity groups in each of which a data transfer has not been performed, a parity group a transfer order of which is earlier than a parity group a transfer order of which is later.

6. The storage device according to claim 1, wherein
the addition address space is managed while the addition address space is divided into pages of a specified size, and
the storage controller selects, as the addition area, a page including an unoccupied region for storing the host data.

7. The storage device according to claim 6, wherein
the storage controller selects, as the addition area, a page a last selection time of which is an oldest of a plurality of addition area candidate pages.

8. The storage device according to claim 1, wherein
the storage controller performs data conversion of reducing a data size of the host data, and adds the converted data to the addition address space.

9. A storage device control method comprising:
managing
a logical volume to which a host makes an access and which manages host data,
an addition address space which is mapped with the logical volume and to which host data is added, and
a physical address space of a plurality of storage drives, the physical address space being mapped with the addition address space;
allocating different address regions to respective parity groups in the addition address space; and
selecting, as an addition area of host data supplied from the host, an unoccupied address region in the addition address space such that,
as the addition area, a region mapped to a normal status parity group in which data recovery is unnecessary is more preferentially selected than a region allocated to an abnormal status parity group in which data recovery is necessary.
